(19) United States
(12) Patent Application Publication
(10) Pub. No.: US 2010/0204828 A1
(43) Pub. Date: Aug. 12, 2010

(54) MOVEMENT PATH GENERATION DEVICE FOR ROBOT

(75) Inventors: Shintaro Yoshizawa, Gotemba-shi (JP); Yutaka Hirano, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI, AICHI (JP)

(21) Appl. No.: 12/670,958

(22) PCT Filed: Jul. 29, 2008
(86) PCT No.: PCT/JP2008/063934

§ 371 Date: Jan. 27, 2010

(30) Foreign Application Priority Data
Jul. 30, 2007 (JP) 2007-197776

(51) Int. Cl. G06F 19/00

(52) U.S. Cl. 700/245

(57) ABSTRACT

A movement path generating device for a robot is provided which can generate a movement path of a jointed robot satisfying a constraint condition and accomplishing optimization of various estimation conditions. The movement path generating device for a robot generating a movement path of a jointed robot with a dynamic constraint includes: constraint condition acquiring means for acquiring a constraint condition of the robot; estimation condition acquiring means for acquiring an estimation condition of the robot; posture generating means for generating a plurality of postures of the robot satisfying the constraint condition; posture estimating means for estimating the plurality of postures generated by the posture generating means on the basis of the estimation condition; posture selecting means for selecting one posture out of the plurality of postures generated by the posture generating means on the basis of the estimation result by the posture estimating means; and movement path generating means for generating the movement path of the robot using the posture selected by the posture selecting means.

### TECHNICAL FIELD

The present invention relates to a movement path generating device for a robot which generates a movement path of a jointed robot with a dynamic constraint.

### BACKGROUND ART

In recent years, various robots such as industrial robots and humanoid robots have been developed. For example, a robot which has plural joints coupled by links and has plural degrees of freedom resulting from movements of the joints is known. Dynamic constraint conditions for causing such a robot to move exist and it is thus necessary to generate a movement path satisfying the constraint conditions. In a motion control device for a robot described in Patent Document 1 (Japanese Unexamined Patent Application Publication No. 2004-306231), tasks given to a legged robot or constraint conditions given depending on motion status are applied by equalities and inequalities relating to a variation from the present state and a driving strategy of a redundant degree of freedom is defined as an energy function. Accordingly, since it is not necessary to construct a control system specialized for each constraint condition for a variation in constraint condition and it is possible to cope with the variation in constraint condition only by variations in matrixes and vectors, it is easy to treat various dynamical constraint conditions. It is possible to cope with a usage of the redundant degree of freedom only by the variations in matrixes and vectors. Japanese Unexamined Patent Application Publication No. 2006-48372 discloses a method of planning a motion path of a robot.

### DISCLOSURE OF THE INVENTION

The optimization problem on estimation conditions of a robot is classified into a linear planning problem in which a linear function is treated and a nonlinear planning problem in which functions (such as a quadratic function, a cubic function, . . . , and any nonlinear function) other than the linear function are treated. However, the motion control device described in Patent Document 1 treats the optimization problem as one in which the estimation function is a quadratic function and can be applied only to the range of a quadratic planning problem. Accordingly, it is not possible to generate a movement path for a robot in which a function more complex than the quadratic function is used as an estimation function.

Therefore, an object of the invention is to provide a movement path generating device for a robot for generating a movement path of a jointed robot satisfying a constraint condition and accomplishing optimization of various estimation conditions.

According to an aspect of the invention, there is provided a movement path generating device for a robot generating a movement path of a jointed robot with a dynamic constraint, including: constraint condition acquiring means for acquiring a constraint condition for constraining a movement of the robot; estimation condition acquiring means for acquiring an estimation condition for estimating the movement of the robot; posture generating means for generating a plurality of postures of the robot satisfying the constraint condition acquired by the constraint condition acquiring means; posture estimating means for estimating the plurality of postures generated by the posture generating means on the basis of the estimation condition acquired by the estimating condition acquiring means; posture selecting means for selecting one posture out of the plurality of postures generated by the posture generating means on the basis of the estimation result by the posture estimating means; and movement path generating means for generating the movement path of the robot using the posture selected by the posture selecting means.

In the movement path generating device for a robot, the constraint condition of the robot is acquired by the constraint condition acquiring means and the estimation condition of the robot is acquired by the estimation condition acquiring means. The constraint condition is a dynamic condition for constraining the movement of the robot and includes, for example, a constraint condition for angles of joints of the robot and a constraint condition for velocities or accelerations of the angles of the joints. The estimation condition is an estimation condition for the movement of the robot and includes, for example, an estimation condition for the torque generated in the joints of the robot, an estimation condition for electric energy consumed in actuators of the joints, and an estimation condition for interference of the posture of the robot with an obstruction. Various conditions can be used as the estimation condition, and a linear function and various nonlinear functions can be used, for example, when an estimation function is used as the estimation condition. In the movement path generating device, plural postures of the robot satisfying the constraint condition are generated by the posture generating means. Here, plural candidates of a subsequent posture in a time series of the robot are generated and all the candidates satisfy the constraint condition. Whenever the plural postures of the robot are generated, the movement path generating device estimates the plural postures on the basis of the estimation condition by the use of the posture estimating means. In the movement path generating device, the posture which is estimated as superior is selected out of the plural postures on the basis of the estimation result of the plural postures by the posture selecting means. Here, the posture which is estimated as superior is selected out of the plural candidates of the subsequent posture in the time series of the robot. In the movement path generating device, the movement path of the robot is generated using the selected posture by the movement path generating means. Accordingly, the movement path generating device can automatically generate the movement path in consideration of the estimation condition while satisfying the constraint condition and can optimize all the estimation conditions employing various nonlinear functions. Therefore, the movement path generating device can cope with more complex planning problems as well as the linear planning problem and the quadratic planning problem.

In the movement path generating device for a robot, the posture generating means may generate the plurality of postures of the robot by randomly generating angles of joints of the robot and may determine whether the constraint condition is satisfied on the basis of variations of the angles of the joints in the generated postures of the robot.

The posture generating means of the movement path generating device randomly generates the angles of the joints of the robot and generates plural postures of the robot including the random angles of the joints. The posture generating means determines whether each generated posture satisfies the constraint condition on the basis of the variations from the angles of the joints in the generated posture relative to the angles of the joints in the previous posture. Only the postures satisfying the constraint condition are estimated by the posture estimating means. Accordingly, it is possible to simply and efficiently generate the candidates of the posture satisfying the constraint condition regardless of the number of joints.

In the movement path generating device for a robot, the posture generating means may generate the plurality of postures of the robot by multiplying the variations of the angles of the joints relative to the previous posture of the robot by a scalar.

When generating the posture including the angles of the joints of the robot, the posture generating means of the movement path generating device generates the posture of the robot by multiplying the variations of the angles of the joints in the generated posture relative to the angles of the joints in the previous posture by a scalar. Accordingly, it is possible to enhance the search efficiency for the posture satisfying the constraint condition.

In the movement path generating device for a robot, the estimation condition may employ an estimation function having the angles of the joints in the postures of the robot as variables, and the posture estimating means may input the angles of the joints of the postures generated by the posture generating means to the estimation function and may estimate the postures on the basis of the output value of the estimation function.

In the movement path generating device for a robot, an estimation function having the angle of each joint in the posture of the robot as a variable is used as the estimation condition. The estimation function employs a first-order function as a linear function, nth-order functions of second or higher-order functions as nonlinear functions, and any nonlinear function. The posture estimating means inputs the joint angles of each posture generated by the posture generating means to the estimation function and estimates the postures on the basis of the output values of the estimation function. Accordingly, it is possible to simply estimate the plural postures using the estimation function and to efficiently select the posture out of the plural postures in consideration of the estimation function.

In the movement path generating device for a robot, the estimation condition may include a plurality of conditions. By setting the plural estimation conditions in this way, it is possible to generate the movement path in consideration of various estimation conditions (such as a small load in an actuator, small power consumption, narrow movement range, and non-interference with an obstruction).

In the movement path generating device for a robot, the estimation condition may include a condition that the posture of the robot does not interfere with an obstruction. By setting the estimation condition to the non-interference of the posture of the robot with the obstruction, it is possible to generate the movement path in which the robot does not collide with the obstruction when moving.

### BRIEF DESCRIPTION OF THE DRAWINGS

FIG. 1 is a diagram illustrating a configuration of a movement path generating device according to an embodiment of the invention.

FIG. 2 is a diagram illustrating an example of a robot used in the embodiment of the invention.

FIG. 3 is a diagram illustrating another example of the robot used in the embodiment of the invention.

FIG. 4 is a diagram illustrating an example of a robot having two joints and two gravitational balancers.

FIG. 5 is a diagram illustrating candidates of joint vectors generated by a posture generating unit shown in FIG. 1.

FIG. 6 is a flowchart illustrating a flow of processes in the movement path generating device according to the embodiment of the invention.

### BEST MODE FOR CARRYING OUT THE INVENTION

Hereinafter, a movement path generating device for a robot according to an embodiment of the invention will be described with reference to the accompanying drawings.

In this embodiment, the movement path generating device for a robot according to the invention is applied to a movement path generating device preparing a movement path of a robot with a multi-degree-of-freedom link system. The movement path generating device according to this embodiment generates a movement path from start position and posture to goal position and posture of the robot, which can satisfy dynamic (kinematic) constraint conditions and optimize estimation conditions. Plural estimation conditions are used in this embodiment. One estimation condition is that the posture of the robot does not interfere with an obstruction and another estimation condition is that an estimation function having an angle of each joint (joint vector) of the robot as a variable is used.

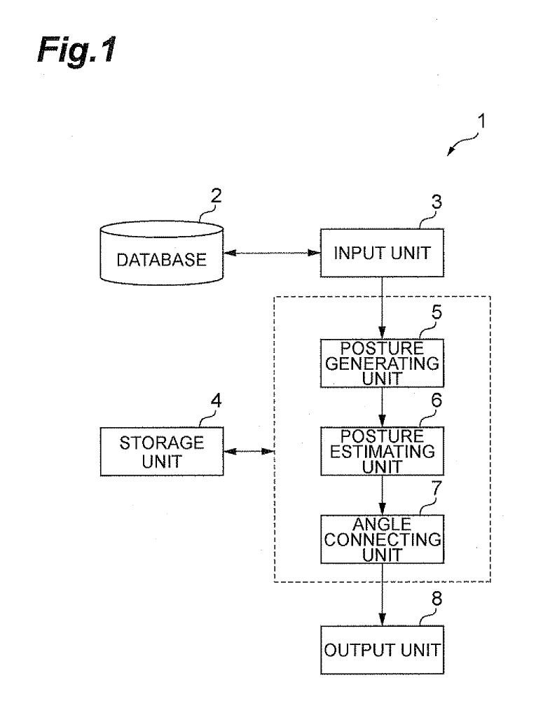

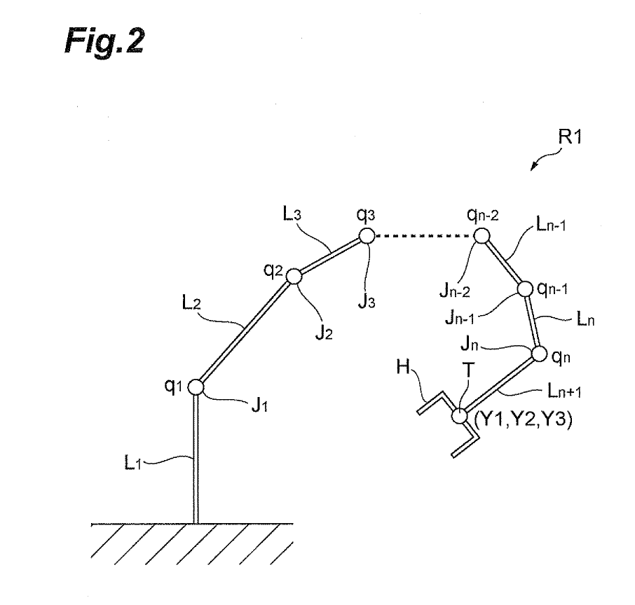

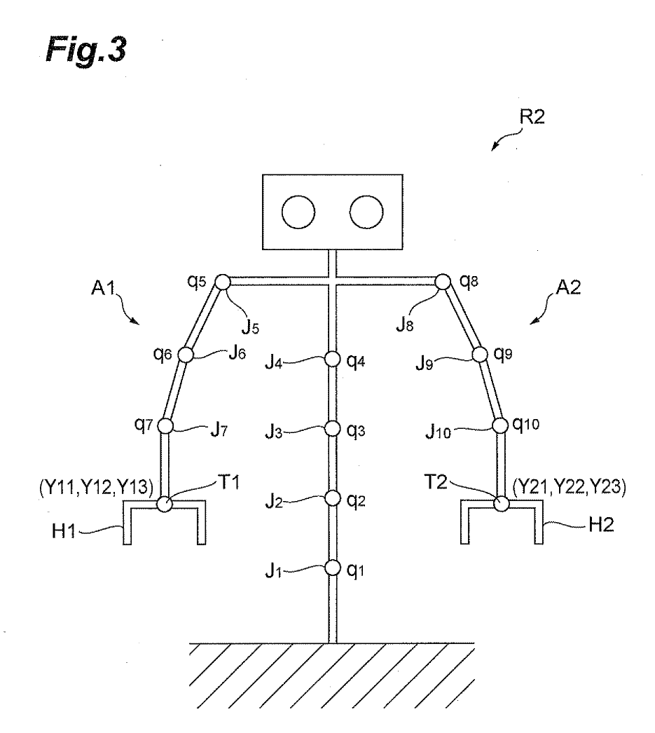

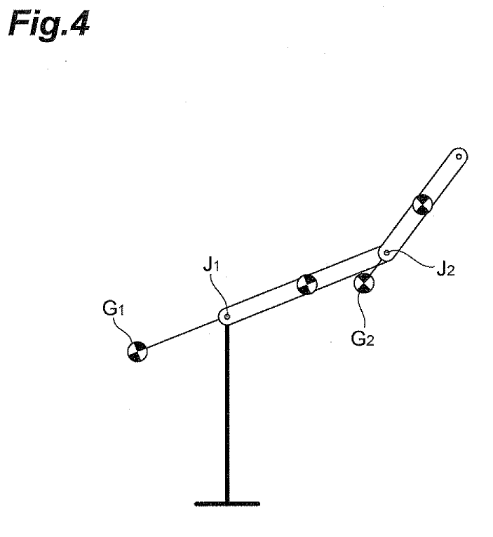

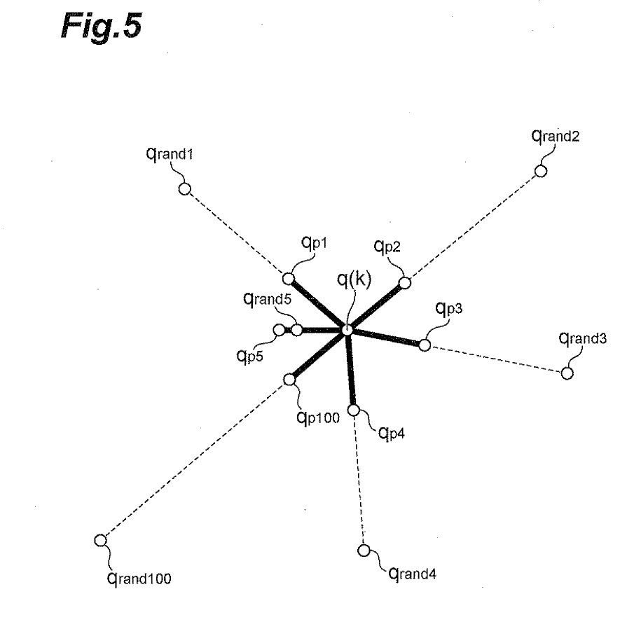

The movement path generating device 1 according to this embodiment will be described with reference to FIGS. 1 to 5. FIG. 1 is a diagram illustrating the configuration of the movement path generating device according to an embodiment of the invention. FIG. 2 is a diagram illustrating an example of a robot used in the embodiment of the invention. FIG. 3 is a diagram illustrating another example of the robot used in the embodiment of the invention. FIG. 4 is a diagram illustrating an example of a robot having two joints and two gravitational balancers. FIG. 5 is a diagram illustrating candidates of joint vectors generated by a posture generating unit shown in FIG. 1.

The movement path generating device 1 automatically prepares the movement path by sequentially calculating the postures (postures which are determined by joint vectors including the angles of the joints) of the robot continuous in time series every predetermined time and connecting the postures continuous in time series. Particularly, to apply various dynamic constraint conditions or estimation functions, the movement path generating device 1 generates plural candidates of the posture of the robot satisfying dynamic constraint conditions and selects one posture, which is estimated as superior by an estimation function and which does not interfere with an obstruction, out of the candidates of the postures.

For this purpose, the movement path generating device 1 includes a database 2, an input unit 3, a storage unit 4, a posture generating unit 5, a posture estimating unit 6, an angle connecting unit 7, and an output unit 8. The main elements of the movement path generating device 1 are constructed by a computer or an electronic control unit in the robot and particularly, the posture generating unit 5, the posture estimating unit 6, and the angle connecting unit 7 are constructed by loading various application programs stored in a hard disk or a ROM to a RAM and executing the programs by the use of a CPU.

In this embodiment, the input unit 3 corresponds to the constraint condition acquiring means and the estimation condition acquiring means in the claims, the posture generating unit 5 corresponds to the posture generating means in the claims, the posture estimating unit 6 corresponds to the posture estimating means and the posture selecting means in the claims, and the angle connecting unit 7 corresponds to the movement path generating means in the claims.

The robot applied to this embodiment will be described now. FIG. 2 shows an example of the robot. The robot R1 includes n joints J₁, . . . , and Jₙ and the joints are connected with links L₁, . . . , and Lₙ₊₁. In the robot R1, one end of a base link L₁ is fixed and a hand H is attached to one end of a tip link Lₙ₊₁. The joints J₁, . . . , and Jₙ have an actuator built therein and rotate to change the angles q₁, . . . , and qₙ between two connected links.

In this way, the robot R1 has n degrees of freedom. These degrees of freedom are expressed as one point (q₁, . . . , and qₙ) in an n-dimensional coordinate space (joint space or configuration space) having coordinate axes for n angles. Actual position and posture of the robot R1 are expressed by a coordinate position (Y1, Y2, Y3) of a tip T (an attachment portion between the link Lₙ₊₁ and the hand H) and the posture of the hand H of the robot R1 in a three-dimensional space (operation space).

Here, q=(q₁, . . . , and qₙ)^{T}, which is called a joint vector is defined by n joint angles q₁, . . . , and qₙ. The joint vector q is a function of time and is expressed by q(1), . . . , q(k−1), q(k), q(k+1), . . . in time series every predetermined time. Accordingly, the joint vector q at time t is q(t)=(q₁(t), . . . , qₙ(t))^{T}.

FIG. 3 shows another example of the robot. The robot R2 is a humanoid robot and has pairs of arms A1 and A2 and hands H1 and H2. The robot R2 includes ten joints J₁, . . . , and J₁₀ and has ten degrees of freedom. In the robot R2, the degrees of freedom are expressed in a coordinate system (q₁, . . . , and q₁₀) in the joint space and the actual position and posture are expressed by the coordinate positions (Y11, Y12, Y13) and (Y21, Y22, Y23) of the tips T1 and T2 and the postures of the hands H1 and H2 in the operation space.

An equation of motion of the robot will be described now. The equation of motion of the robot is expressed by Expression 1. In Expression 1, the first term of the left side represents the acceleration of the joint vector, the second term represents the velocity of the joint vector, the third term represents the gravitational force, and the right side represents the torque acting on n joints.

$$\begin{matrix}Expression 1 & \\ H ( q ) \times \frac{{d}^{2} q}{d {t}^{2}} + C ( \frac{d q}{d t} , q ) \times \frac{d q}{d t } + G ( q ) = τ & ( 1 )\end{matrix}$$

In Expression 1, d²q/dt² is the second-order temporal differentiation of the joint vector q and dq/dt is the first-order temporal differentiation of the joint vector q. H(q) is a matrix expressing the force of inertia acting on the robot, C(dq/dt, q) is a matrix expressing the centrifugal force and the Coriolis force acting on the robot, and G(q) is a vector expressing the gravitational force acting on the robot.

The constraint condition will be described now. The constraint condition is a dynamical (kinematical) condition for constraining the movement of the robot during the movement of the robot. Examples of the constraint condition are expressed by Expressions 2, 3, and 4. Expression 2 expresses the constraint condition for the position and posture of the robot. Expression 3 expresses the constraint condition for the position and posture and the velocity of the robot and an example thereof is that the robot is made to move at a constant velocity. Expression 4 expresses the constraint condition for the position and posture, the velocity, and the acceleration of the robot and an example thereof is that the robot is made to move at a constant acceleration.

$$\begin{matrix}Expression 2 , 3 , and 4 & \\ {h}_{1} ( q , t ) = 0 ∈ {R}^{m} & ( 2 ) \\ {h}_{2} ( \frac{d q}{d t} , q , t ) = 0 ∈ {R}^{m} & ( 3 ) \\ {h}_{3} ( \frac{{d}^{2} q}{d {t}^{2}} , \frac{d q}{d t} , q , t ) = 0 ∈ {R}^{m} & ( 4 )\end{matrix}$$

The constraint conditions may include various conditions other than the above-mentioned conditions. For example, the constraint conditions may be a conditional expression including an inequality and may be a conditional expression including the third or higher-order temporal differentiation.

For example, when the angle of the joint i at time t−Δt/2 prior to time t by Δt/2 is qᵢ(t−Δt/2) and the angle of the joint i at time t+Δt/2 subsequent to time t by Δt/2 is qᵢ(t+Δt/2), the first-order temporal differentiation of the angle qᵢ of the joint i can be approximated by qᵢ(t−Δt/2) and qᵢ(t+Δt/2) as expressed by Expression 5, where Δt is a very short time.

$$\begin{matrix}Expression 5 & \\ \frac{d {q}_{i}}{d t} ≅ \frac{{q}_{i} ( t + Δ t / 2 ) {q}_{i} ( t - Δ t / 2 )}{Δ t} = \frac{{q}_{i} ( t + Δ t / 2 )}{Δ t} - \frac{{q}_{i} ( t - Δ t / 2 )}{Δ t} & ( 5 )\end{matrix}$$

Accordingly, the temporal differentiation of the angle qᵢ of the joint i is generalized and defined by Expression 6. In Expression 6, superscript (m) represents the m-th order temporal differentiation and the superscript (m−1) represents the (m−1)-th order temporal differentiation.

$$\begin{matrix}Expression 6 & \\ {q}_{i}^{( m )} ( t , Δ t ) = \frac{{q}_{i}^{( m - 1 )} ( t - Δ t / 2 , Δ t ) - {q}_{i}^{( m - 1 )} ( t - Δ t / 2 , Δ t )}{Δ T} & ( 6 )\end{matrix}$$

When the first-order temporal differentiation of the angle qᵢ of the joint i is expressed by the zeroth-order temporal differentiation of the angle qᵢ of the joint i, Expression 7 is obtained. Here, since qᵢ⁽⁰⁾ in Expression 7 means the zeroth-order temporal differentiation of the angle qᵢ of the joint, qᵢ⁽⁰⁾=qᵢ is set. In addition, qᵢ(k)=qᵢ(t−Δt/2, Δt)/Δt and qᵢ(k+1)=qᵢ(t+Δt/2, Δt) Δt are set. Accordingly, the first-order temporal differentiation of the angle qᵢ of the joint i at time t=k can be expressed by a difference formula between two terms of the angle qᵢ(k) of the joint i at time k and the angle qᵢ(k+1) of the joint i at the subsequent time k+1, as expressed by Expression 8.

Expressions 7 and 8

qᵢ⁽¹⁾(t)=lim_{Δt→0}qᵢ⁽⁰⁾(t,Δt) (7)

qᵢ⁽¹⁾(k)=qᵢ(k+1)−qᵢ(k) (8)

In this way, the m-th order temporal differentiation of an angle qᵢ of a joint i can be approximated by the difference formula using the (m+1)-th term of the angle qᵢ. Accordingly, the constraint condition can be also approximated by the difference formula using the (m+1)-th term of the angle qᵢ of each joint i. As a result, the constraint conditions can be determined on the basis of the difference between the (m+1)-th terms of the angles qᵢ of the joints i. For example, in Expression 3, since the constraint condition expression has the first-order temporal differentiation of the joint vector q (the angle qᵢ of each joint i) as a variable, it can be expressed by the relational expression of two terms of the joint vectors q(k) and q(k+1) (the angles qᵢ(k) and qᵢ(k+1) of each joint i). In Expression 4, since the constraint condition expression has the second-order temporal differentiation of the joint vector q as a variable, it can be expressed by the relational expression of three terms of the joint vectors q(k−1), q(k), and q(k+1) (the angles qᵢ(k−1), qᵢ(k), and qᵢ(k+1) of each joint i). In this way, in this embodiment, the constraint conditions are treated by the approximation using the difference formula of the joint vectors q continuous in time series.

The estimation function (estimation indicator) will be described now. The estimation function is a function representing an estimation condition at the time of causing the robot to move. Examples of the estimation condition include a condition that the torque generated in the joint of the robot is reduced as small as possible and a condition that the electric energy consumed in the actuator is reduced. As the estimation function, a first-order function as a linear function, nth-order functions of second or higher-order functions as nonlinear functions, or any nonlinear function can be used, and all functions can be used.

When the robot is made to move from the start position and posture to the goal position and posture, an infinite number of movements of the robot exist. Accordingly, when p joint vectors q(1), q(2), . . . , and q(p) defining p postures continuous in time series are determined, the (p+1)-th joint vector q(p+1) is determined so that the value of the estimation function for the p joint vectors is minimized (or maximized) (that is, is estimated as the most superior).

In this embodiment, the function F(q(k−p+1), . . . , q(k), q(k+1)) of the p+1 continuous joint vectors q(k-p+1), . . . , q(k), and q(k+1) is used as the estimation function. On the basis of the p joint vectors q(k−p+1), . . . , q(k), the joint vector of which the estimation function value is minimized (or maximized) is selected out of the plural candidates (candidates satisfying the constraint condition) of the joint vector q(k+1) and the (k+1)-th joint vector q(k+1) is determined.

Two examples of the estimation function are described below. In the first example, a function for calculating the total sum of the torques generated in the joints is used as the estimation function and the joint vector minimizing the value of the estimation function is selected. In this way, by minimizing the total sum of the torques generated in the joints, it is possible to minimize the total load in the actuators and to suppress the load in the actuators. The estimation function C is expressed by Expression 9.

$$\begin{matrix}Expression 9 & \\ C = {\sum }_{i} {( \frac{d {τ}_{ i}}{d t} )}^{2} & ( 9 )\end{matrix}$$

In Expression 9, τᵢ represents the torque generated in the joint i (that is, the actuator). Here, to simplify the description, a robot having two joints J₁ and J₂ and two gravitational balancers G₁ and G₂ shown in FIG. 4 is considered. In this robot, since the gravitational balancers G₁ and G₂ exist, the centrifugal force and the Coriolis force are 0, the gravitational force is 0, and the force of inertia is constant. Accordingly, the torque τᵢ of the joint i can be expressed by Expression 10 on the basis of the equation of motion of the robot shown in Expression 1. In Expression 10, H is an inertia matrix of time constants.

$$\begin{matrix}Expression 10 & \\ H \times \frac{{d}^{2} {q}_{i}}{d {t}^{2}} = {τ}_{i} & ( 10 )\end{matrix}$$

Accordingly, the estimation function C can be expressed by the square sum of the values of the third-order temporal differentiation of the joint angles qᵢ. As described above, the third-order temporal differentiation of the joint angles qᵢ can be approximated by the difference formula of four terms of qᵢ(k−2), qᵢ(k−1), qᵢ(k), and qᵢ(k+1) which are continuous in time series. Accordingly, the estimation function C can be expressed by the nonlinear function of two-dimensional joint vectors q(k−2), q (k−1), q (k), and q (k+1). Incidentally, when n functions exist, the nonlinear function of n-dimensional joint vectors is obtained.

In the second example, a function for calculating the total sum of electric energy consumed in the actuators is used as the estimation function and a joint vector minimizing the value of the estimation function is selected. In this way, by minimizing the total sum of electric energy consumed in the actuators, it is possible to suppress the power consumption of the robot. The estimation function J is expressed by Expression 11.

Expression 11

J=I(t)^{T}×R×I(t) (11)

Iᵢ(t) is the current consumed in the motor of the actuator driving the joint i. Accordingly, the current vector in Expression 11 is I(t)=(I₁(t), . . . , Iₙ(t))^{T}. Rᵢ represents the resistance value in the motor driving the joint i in consideration of loss in the motor of the joint i and a power conversion circuit controlling the motor. Accordingly, the resistance vector in Expression 11 is R=diag(R₁, . . . , Rₙ).

The relational expression of the torque and the current is expressed by Expression 12. K in Expression 12 is a torque constant. Here, when the robot having two joints J₁ and J₂ and two gravitational balancers G₁ and G₂ is considered, the current vector I(t) is expressed as the second-order temporal differentiation of the joint vector q from Expressions 10 and 12. Accordingly, the estimation function J can be expressed by the nonlinear function of two-dimensional joint vectors q(k−1), q(k), and q(k+1).

Expression 12

τ(t)=K×I(t) (12)

In this way, in this embodiment, the estimation function F is treated as the difference formula of the joint vectors q continuous in time series. When the estimation function F is continuous, it is possible to generate the movement path of the robot using any nonlinear estimation function F. Accordingly, it should be assumed that the estimation function F is continuous.

The elements of the movement path generating device 1 will be described below. The database 2 is constructed by a predetermined area of the hard disk or the RAM. Shape data of the robot (such as shapes and sizes of the parts of the robot), structure data (such as the link length and the maximum rotational angle range of the joints), and environment data (such as obstruction information and work target information of the robot) in which the robot works are stored in the database 2. The obstruction information includes the position, the shape, and the size of an obstruction. The environment data may not be stored in advance in the database 2, but may be acquired by various sensors (such as a millimeter-wave sensor, an ultrasonic sensor, a laser sensor, a range finder, and a camera sensor) mounted on the robot. In this case, the acquired environment data are stored in the storage unit 4. Regarding the sensors, a camera may be attached to a portion corresponding to an eye of a face part, for example, in the case of the humanoid robot shown in FIG. 3.

The input unit 3 is means for an operator's input or selection and may include a mouse, keys, or a touch panel. The operator can input or select, by the use of the input unit 3, the start position and posture and the goal position and posture of the robot (the positions and postures defined by the joint vectors q), the estimation functions and estimation methods thereof, the constraint conditions and determination methods thereof, a step size c (corresponding to the step size between the joint vectors continuous in time series) used to search for the candidates satisfying the constraint conditions, the threshold value δ used to determine whether the constraint conditions are satisfied, and the lower limit value N (corresponding to the lower limit value of the estimation number in the posture estimating unit 6) of the number of candidates satisfying the constraint conditions.

The storage unit 4 is formed by a predetermined area of the RAM. The storage unit 4 temporarily stores the processing results in the posture generating unit 5, the posture estimating unit 6, and the angle connecting unit 7.

The posture generating unit 5 generates N or more candidates of the joint vector q(k+1) at the next time k+1 satisfying the constraint conditions. Here, to simplify the description, it is assumed that the constraint condition (Expression 13) for approximating the first-order temporal differentiation of the joint vector expressed by Expression 3 using two terms q(k) and q(k+1) is input as the constraint condition. Since the joint vector q(k) is determined by the previous process, the posture generating unit 5 generates N or more candidates of a new joint vector q(k+1) in the present process. FIG. 5 shows a joint space which is centered on the joint vector q(k).

Expression 13

h₂(q(k+1),q(k))=0 (13)

First, the posture generating unit 5 randomly generates plural vectors q_{rand1}, q_{rand2}, . . . having the joint vector q(k) as a start point using a random number. Specifically, the angles qᵢ of the joints i in the vectors q_{rand} are randomly generated using the random number. In the example shown in FIG. 5, 100 vectors q_{rand1}, q_{rand2}, . . . , and q_{rand100} are generated. The posture generating unit 5 projects the vectors q_{rand1}, q_{rand2}, . . . to the positions where the distance from the joint vector q(k) is equal to the step size ε to generate candidate vectors qₚ₁, qₚ₂, . . . . For example, regarding the vector q_{randj}, the candidate vector qₚⱼ is expressed by Expression 14.

$$\begin{matrix}Expression 14 & \\ {q}_{pj} = ɛ \times \frac{{q}_{randj} - q ( k )}{‖ {q}_{randj} - q ( k ) ‖} & ( 14 )\end{matrix}$$

As expressed in Expression 14, the vector obtained by multiplying a unit vector from q(k) to q_{randj} by the step size ε is the candidate vector qₚⱼ. In other words, by multiplying the vector q_{randj}−q(k) by a scalar multiple of the norm ε/(q_{randj}−q(k)), the vector qₚⱼ is generated. Specifically, the angles qᵢ of the joint i of the vector q_{randj} randomly generated—the angle qᵢ of the joint i of q(k)) is multiplied by a scalar.

For each of the generated candidate vectors qₚ₁, qₚ₂, . . . , the posture generating unit 5 inputs the joint vector q(k) and the candidate vector qₚⱼ (specifically, the angle qᵢ of the joint i of q(k) and the angle qᵢ of the joint i of qₚⱼ) into Expression 13 and calculates the value of h₂(q(k+1), q(k)). The posture generating unit 5 determines whether the value of h₂(q(k+1), q(k)) is equal to or less than the threshold value δ.

Incidentally, a great process load and much time are required to search for the candidate vectors exactly satisfying the constraint condition (that is, the value of h₂(q(k+1), q(k)) is 0). Accordingly, the candidate vectors necessarily and sufficiently satisfying the constraint condition are searched for using the threshold value δ. The threshold value δ is set by the operator in consideration of the shape or structure of the robot, the work precision of the robot, the process load, and the like.

The posture generating unit 5 determines whether the number of candidate vectors of which the value of h₂(q(k+1), q(k)) is equal to or less than the threshold value δ out of the candidate vectors qₚ₁, qₚ₂, . . . randomly generated is equal to or greater than N. When the number of candidate vectors is less than N, the posture generating unit 5 generates the candidate vectors qₚ₁, qₚ₂, . . . different from those of the previous time in the same way as described above and selects the candidate vectors satisfying the constraint condition therefrom. In this way, the posture generating unit 5 performs the above-mentioned process until determining N or more candidate vectors qₚₚ₁, qₚₚ₂, . . . , and q_{ppM} of the joint vector q(k+1) satisfying the constraint condition.

Incidentally, when the estimation number in the posture estimating unit 6 is set to be N or more, it is to determine the joint vector q(k+1) which is estimated as superior as possible. As the value of N becomes greater, the probability of determining the joint vector q(k+1) which is estimated as superior becomes higher. However, as the value of N becomes greater, the process load becomes greater. Accordingly, N is determined by the operator in consideration of the estimation level of the robot, the precision, the process load, and the like.

In this way, the posture generating unit 5 determines N or more candidate vectors qₚₚ₁, qₚₚ₂, . . . , and q_{ppM} satisfying the constraint condition using δ as the threshold value. For example, when the constraint condition is that the second-order temporal differentiation is approximated by the difference between three terms of q(k−1), q(k), and q(k+1), N or more candidate vectors qₚₚ₁, qₚₚ₂, . . . , and q_{ppM} of q(k+1) are determined using the previously determined q(k−1) and q(k). When the constraint condition is that the third-order temporal differentiation is approximated by the difference between four terms of q(k−2), q(k−1), q(k), and q(k+1), N or more candidate vectors qₚₚ₁, qₚₚ₂, and q_{ppM} of q(k+1) are determined using the previously determined q(k−2), q(k−1), and q(k).

The posture estimating unit 6 determines one joint vector q(k+1), which is estimated as superior and does not interfere with an obstruction, out of the candidates qₚₚ₁, qₚₚ₂, . . . , and q_{ppM} of the joint vector q(k+1) satisfying the constraint condition generated by the posture generating unit 5 using the estimation function. Here, to simplify the description, it is assumed that the estimation function is F(q(k), q(k+1)). Since the joint vector q(k) is determined by the previous process, the posture estimating unit 6 determines one joint vector q(k+1) out of the candidate vectors qₚₚ₁, qₚₚ₂, . . . , and q_{ppM} of the joint vector q(k+1) in the present process.

For each of the candidate vectors qₚₚ₁, qₚₚ₂, . . . , and q_{ppM}, the posture estimating unit 6 inputs the joint vector q(k) and the candidate vector qₚₚⱼ (specifically, the angle qᵢ of the joint i of q(k) and the angle qᵢ of the joint i of qₚₚⱼ) into the estimation function F and calculates the value of the estimation function F. The posture estimating unit 6 compares the values of the estimation functions F of all the candidate vectors qₚₚ₁, qₚₚ₂, . . . , and q_{ppM} with each other and selects the candidate vector qₒₚₜ₁ having the minimum value of the estimation function F (that is, which is estimated as the most superior). Here, the candidate vector having the maximum value of the estimation function F may be estimated as the most superior depending on the estimation function F.

Then, the posture estimating unit 6 connects the joint vector q(k) to the selected candidate vector qₒₚₜ₁ and generates a segment of line (a branch). The posture estimating unit 6 determines whether the parts of the robot with the posture determined by the joint vectors in the generated segment of line interferes with the obstruction in the working environment. When the interference with the obstruction exists (that is, when the robot collides with the obstruction), the posture estimating unit 6 compares the values of the estimation function F of all the candidate vectors qₚₚ₁, qₚₚ₂, . . . , and q_{ppM} again and selects the candidate vector qₒₚₜ₂ having the second maximum value of the estimation function F. Then, the posture estimating unit 6 determines whether the segment of line between the joint vector q(k) and the candidate vector qₒₚₜ₂ interferes with the obstruction, as described above. In this way, the posture estimating unit 6 performs the above-mentioned processes until determining the candidate vector qₒₚₜ not interfering with the obstruction.

When the candidate vector qₒₚₜ not interfering with the obstruction is determined, the posture estimating unit 6 sets the candidate vector qₒₚₜ as the joint vector q(k+1) at time k+1. That is, one joint vector q(k+1) of which the value of the estimation function F is estimated as superior as possible and in which the robot does not collide with the obstruction is determined out of the candidate vectors qₚₚ₁, qₚₚ₂, . . . , and q_{ppM}. For example, when the estimation function is F(q(k−1), q(k), q(k+1)), one joint vector q(k+1) is determined out of the candidate vectors using the previously determined q(k−1) and q(k). When the estimation function is F(q(k−2), q(k−1), q(k), q(k+1)), one candidate vector q(k+1) is determined out of the candidate vectors using the previously determined q(k−2), q(k−1), and q(k).

When the joint vectors are determined by the posture estimating unit 6, the angle connecting unit 7 connects the joint vectors q continuous in time series and generates the movement path from the start to the goal of the robot. Specifically, when the joint vector q(k+1) is determined by the posture estimating unit 6, the angle connecting unit 7 connects the previously determined joint vector q(k) to the joint vector q(k+1) (specifically, connects the angle qᵢ of the joint i of the joint vector q(k) to the angle qᵢ of the joint i of the joint vector q(k+1)) and interpolates the joint vectors (the angle qᵢ of each joint i) in the connected segment of line. In this way, the angle connecting unit 7 generates the movement path using the joint vectors continuous in time series from the start to the goal. Incidentally, when the movement path is generated, the joint vectors may be extended from the start to the goal, the joint vectors may be extended from the goal to the start, or the joint vectors may be extended from both the start and the goal.

The output unit 8 is means for outputting the movement path generated by the angle connecting unit 7. The output unit 8 is, for example, a monitor, a printer, or a communication unit communicating with a control unit which controls the movement of the robot. When it has a function as the control unit controlling the robot, the output unit 8 controls the driving of the actuators of the joints of the robot on the basis of the joint vectors in the movement path.

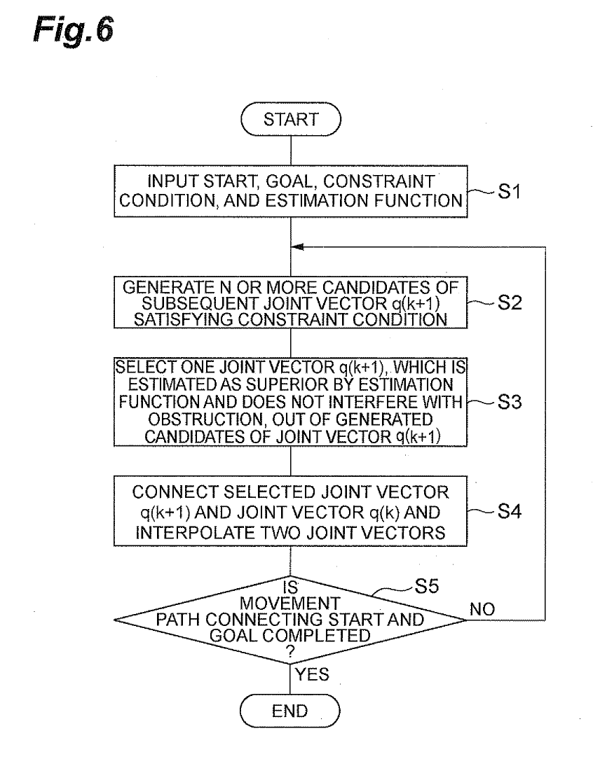

The operation of the movement path generating device 1 shown in FIG. 1 will be described below with reference to the flowchart shown in FIG. 6. FIG. 6 is a flowchart illustrating a flow of operations of the movement path generating device according to this embodiment.

The shape data or structure data of the robot and the environment data are stored in advance in the database 2 of the movement path generating device 1. In the movement path generating device 1, the start position and posture and the goal position and posture (joint vectors) of the robot, the estimation function and estimating method thereof, the constraint condition and determining method thereof, the step size ε, the threshold value δ, and the number of candidates N are input from the input unit 3 by the operator (S1). For example, when the three-term joint vectors are used for the estimation function and the constraint condition, it is necessary to input the joint vectors q(1) and q(2). When the four-term joint vectors are used, it is necessary to input the joint vectors q(1), q(2), and q(3).

The posture generating unit 5 randomly generates the candidate vectors qₚ₁, qₚ₂, . . . using a random number and selects N or more candidate vectors qₚₚ₁, qₚₚ₂, . . . , and q_{ppM} of the next joint vector q(k+1) satisfying the constraint condition using δ as the threshold value out of the candidate vectors qₚ₁, qₚ₂, . . . (S2). The posture estimating unit 6 selects one joint vector q(k+1), the value of the estimation function F of which is estimated as superior as possible and which does not interfere with an obstruction, out of the candidate vectors qₚₚ₁, qₚₚ₂, . . . , and q_{ppM} of the next joint vector q(k+1) (S3). The angle connecting unit 7 connects the selected joint vector q(k+1) and the previous joint vector q(k) and interpolates the segment of line therebetween (S4).

The angle connecting unit 7 determines whether the movement path including the joint vectors q in time series from the start to the goal is completed (S5). When it is determined in S5 that the movement path is not completed, the movement path generating device 1 performs the processes of steps S2 to S4 from S2. When it is determined in step S5 that the movement path is completed, the movement path generating device 1 outputs the movement path through the output unit 8.

According to the movement path generating device 1, it is possible automatically to generate the movement path which allows the robot to satisfy the constraint condition and not to collide with an obstruction and which considers the estimation conditions. Particularly, in the movement path generating device 1, a linear function or various nonlinear functions can be employed as the estimation function, thereby optimizing all the estimation conditions. For example, when very complex nonlinear functions shown in Expressions 9 and 11 are used as the estimation function, it is possible to generate the movement path which can optimize the estimation conditions for the estimation functions. Accordingly, it is possible to cope with all the optimization problems for the movement path of the robot.

In the movement path generating device 1, by randomly generating the candidate joint vectors (the angles of the joints) using a random number, it is possible simply and efficiently to generate the candidate vectors regardless of the number of joints. In the movement path generating device 1, by multiplying the difference between the joint vectors (difference between the angles of the joints) by a scalar number to generate the candidate joint vectors, it is possible simply to generate the candidate vectors and to enhance the search efficiency for the posture satisfying the constraint condition.

In the movement path generating device 1, by approximating the constraint condition using the difference between the joint vectors continuous in time series, it is possible to simplify the constraint condition and efficiently to determine the constraint condition. In the movement path generating device 1, by approximating the estimation function using the difference between the joint vectors continuous in time series, it is possible to simplify the estimation function and efficiently to select one joint vector out of the plural candidate vectors in consideration of the estimation function.

While the embodiment of the invention has been described, the invention is not limited to the embodiment but may be modified in various forms.

For example, although the embodiment has been applied to a robot having plural joints which rotate, the invention may be applied to a robot having joints which act in other ways such as a telescopic action or a robot which moves in a one-dimensional line, a two-dimensional plane, or a three-dimensional space.

Although two conditions of the non-interference by an obstruction and the use of an estimation function have been used as the estimation condition in the embodiment, the number of estimation conditions may be one or three or more.

Although the constraint condition and the estimation condition have been input through the input unit in the embodiment, these conditions may be acquired by other means, and for example, the conditions may be stored in advance in storage means such as a database.

### INDUSTRIAL APPLICABILITY

According to the movement path generating device for a robot of the invention, it is possible to generate a movement path of a robot which satisfies a constraint condition and which optimizes various estimation conditions.

1. A movement path generating device for a robot generating a movement path of a jointed robot with a dynamic constraint, the movement path generating device comprising:
constraint condition acquiring means for acquiring a constraint condition for constraining a movement of the robot;
estimation condition acquiring means for acquiring an estimation condition for estimating the movement of the robot;
posture generating means for generating a plurality of postures of the robot satisfying the constraint condition acquired by the constraint condition acquiring means;
posture estimating means for estimating the plurality of postures generated by the posture generating means on the basis of the estimation condition acquired by the estimating condition acquiring means;
posture selecting means for selecting one posture out of the plurality of postures generated by the posture generating means on the basis of the estimation result by the posture estimating means; and
movement path generating means for generating the movement path of the robot using the posture selected by the posture selecting means.

2. The movement path generating device according to claim 1, wherein the posture generating means generates the plurality of postures of the robot by randomly generating angles of joints of the robot and determines whether the constraint condition is satisfied on the basis of variations of the angles of the joints in the generated postures of the robot.

3. The movement path generating device according to claim 1, wherein the posture generating means generates the plurality of postures of the robot by multiplying the variations of the angles of the joints from the previous posture of the robot by a scalar.

4. The movement path generating device according to claim 1, wherein the estimation condition employs an estimation function having the angles of the joints in the postures of the robot as variables, and
wherein the posture estimating means inputs the angles of the joints of the postures generated by the posture generating means to the estimation function and estimates the postures on the basis of the output value of the estimation function.

5. The movement path generating device according to claim 1, wherein the estimation condition includes a plurality of conditions.

6. The movement path generating device according to claim 1, wherein the estimation condition includes a condition that the posture of the robot is not interfered with by an obstruction.
